(19) United States
(12) Patent Application Publication
(10) Pub. No.: US 2015/0092952 A1
(43) Pub. Date: Apr. 2, 2015

(54) Audio Device and Control Method

(71) Applicant: Kabushiki Kaisha Toshiba, Tokyo (JP)

(72) Inventors: Takashi Sudo, Fuchu-shi (JP); Yasuhiro Kanishima, Tokyo (JP)

(21) Appl. No.: 14/327,412

(22) Filed: Jul. 9, 2014

(30) Foreign Application Priority Data
Sep. 30, 2013 (JP) 2013-204506

(51) Int. Cl. H04R 1/10; H04R 3/00; H04R 1/08

(52) U.S. Cl. CPC H04R 1/1041; H04R 1/08; H04R 3/00
USPC 381/71.6

(57) ABSTRACT

According to one embodiment, an audio device includes a first driver, a first acoustic cylinder, a body temperature sensor, and a corrector. The first driver outputs a sound. The first acoustic cylinder includes a first pathway configured to be passed through by a sound. The first pathway includes an opening configured to face an eardrum of a wearer. The body temperature sensor is provided substantially in an center of the opening or outside of a plane of the opening. The corrector corrects first audio data to suppress resonance in the first pathway. The first driver outputs corrected first sound according to corrected first audio data.

### CROSS-REFERENCE TO RELATED APPLICATIONS

This application is based upon and claims the benefit of priority from Japanese Patent Application No. 2013-204506, filed Sep. 30, 2013, the entire contents of which are incorporated herein by reference.

### FIELD

Embodiments described herein relate generally to an audio device and a control method.

### BACKGROUND

Recently, home-based preventive medicine and healthcare have been drawing attention. In addition, medical equipment has been miniaturized. Here, it is proposed to put a piece of miniaturized equipment on the body to measure a physiological signal such as the pulse.

It is considered to mount a body temperature sensor on auditory canal earphones (audio device). The body temperature sensor absorbs infrared energy radiated from the eardrum and measures the body temperature based on a voltage change produced by the absorbed infrared energy.

The body temperature sensor must face the eardrum to absorb the infrared energy radiated from the eardrum. However, since the egress of sound is blocked, the sound quality may be degraded when the sound is output.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing a structure of auditory canal earphones according to an embodiment.

FIG. 2A and FIG. 2B are exemplary diagrams showing a structure of a left earpiece module of the auditory canal earphones according to an embodiment.

FIG. 3A and FIG. 3B are exemplary diagrams showing a structure of a right earpiece module of the auditory canal earphones according to an embodiment.

FIG. 4 is an exemplary block diagram showing a system configuration of the auditory canal earphones according to an embodiment.

FIG. 5 is an exemplary block diagram showing a system configuration of a first modified example of the earphones according to an embodiment.

FIG. 6 is an exemplary diagram showing an exterior of a second modified example of the earphones according to an embodiment.

FIG. 7 is an exemplary block diagram showing a system configuration of the second modified example of the earphones according to an embodiment.

FIG. 8 is an exemplary block diagram showing a system configuration of a third modified example of the earphones according to an embodiment.

FIG. 9 is an exemplary diagram showing a structure of a fourth modified example of the earphones according to an embodiment.

FIG. 10 is an exemplary diagram showing a structure of the fourth modified example of the earphones according to an embodiment.

FIG. 11 is an exemplary diagram showing a structure of a fifth modified example of the earphones according to an embodiment.

### DETAILED DESCRIPTION

Various embodiments will be described hereinafter with reference to the accompanying drawings.

In general, according to one embodiment, an audio device includes a first driver, a first acoustic cylinder, a body temperature sensor, and a corrector. The first driver outputs a sound. The first acoustic cylinder includes a first pathway configured to be passed through by a sound. The first pathway includes an opening configured to face an eardrum of a wearer. The body temperature sensor is provided substantially in an center of the opening or outside of a plane of the opening. The corrector corrects first audio data to suppress resonance in the first pathway. The first driver outputs corrected first sound according to corrected first audio data.

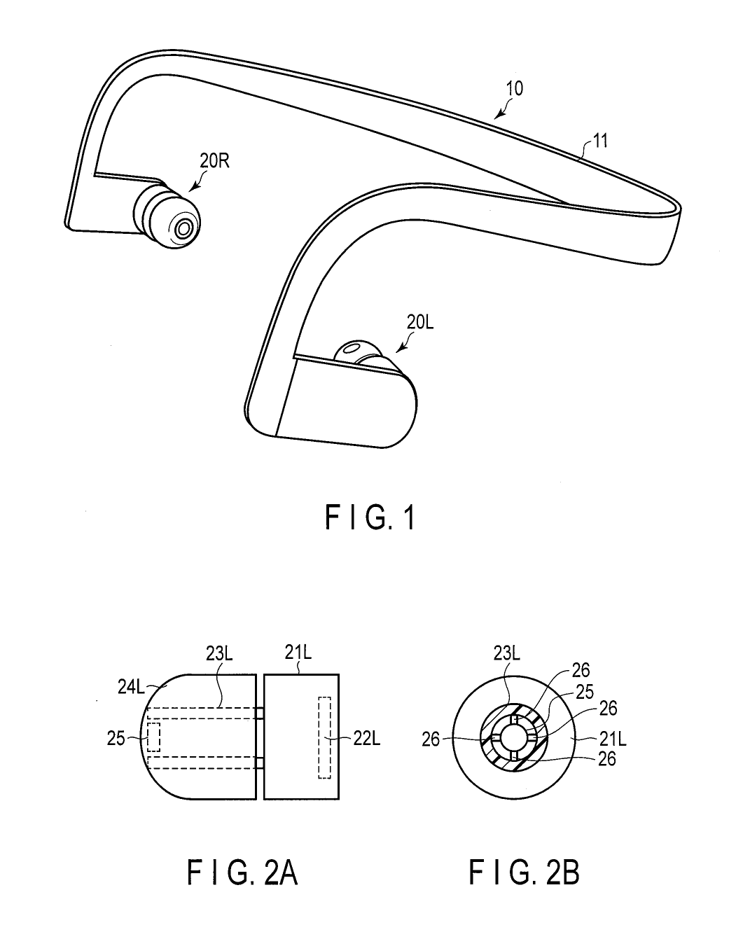

FIG. 1 illustrates the exterior of auditory canal earphones (audio device) 10 according to an embodiment.

As shown in FIG. 1, the earphones 10 comprise a hardware neckband 11, a left earpiece module 20L, a right earpiece module 20R, and the like.

FIG. 2 illustrates a structure of the left earpiece module 20L. FIG. 2A is a sectional view of the structure of the left earpiece module 20L. FIG. 2B is a plan view of the structure of the left earpiece module. FIG. 2B is a plan view from a side which faces the eardrum when the device is put on.

The left earpiece module 20L comprises a housing 21L, a driver unit 22L, an acoustic cylinder part 23L, an ear seating 24L, a body temperature sensor 25, ribs 26 and the like.

In housing 21L, driver unit 22L is provided. Driver unit 22L is configured to output sound of a left channel according to an input left-channel audio signal. Acoustic cylinder part 23L comprises a pathway through which the sound of the left-channel output from driver unit 22L passes. The pathway in acoustic cylinder part 23L comprises an opening which faces the eardrum. Ear seating 24L is mounted on acoustic cylinder part 23L. The body temperature sensor 25 is provided substantially in the center of the opening of acoustic cylinder part 23L. More specifically, the body temperature sensor 25 is provided substantially at the center of the plane of the opening of acoustic cylinder part 23L. The body temperature sensor 25 is configured to absorb infrared energy radiated from the eardrum and to measure the body temperature based on a voltage change produced by the absorbed infrared energy. The body temperature sensor 25 is secured to acoustic cylinder part 23L with the ribs 26.

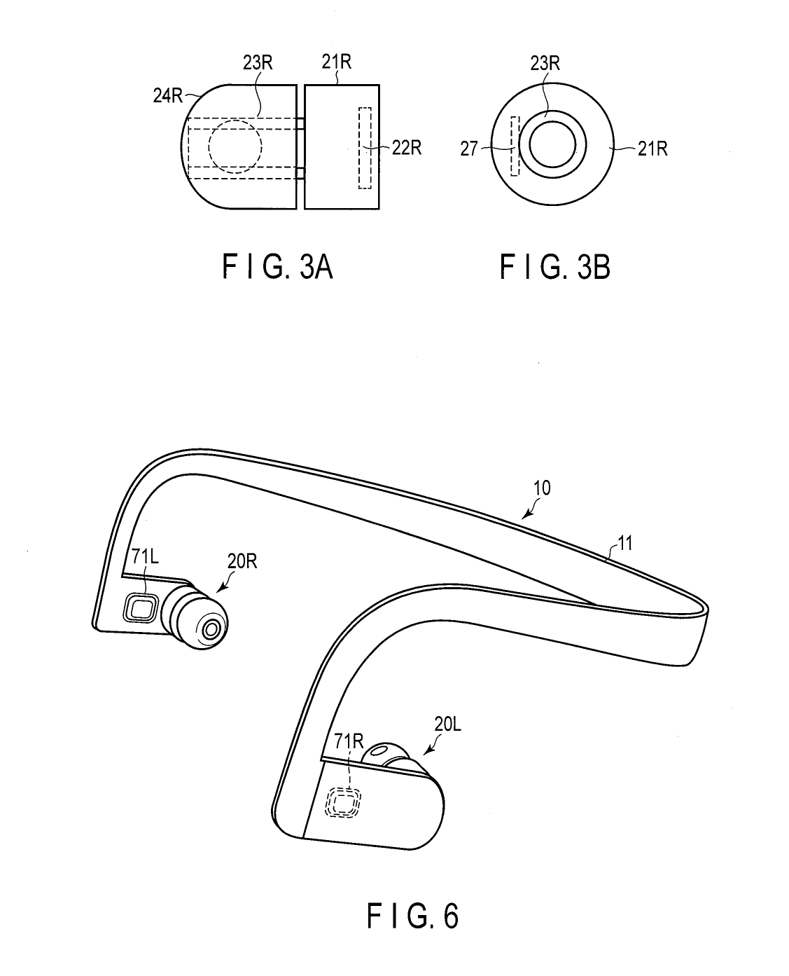

FIG. 3 illustrates a structure of a right earpiece module 20R. FIG. 3A is a sectional view of the structure of the right earpiece module. FIG. 3B is a plan view of the structure of the right earpiece module. FIG. 3B is a plan view from a side which faces the eardrum when the device is put on.

The right earpiece module 20R comprises a housing 21R, a driver unit 22R, an acoustic cylinder part 23R, an ear seating 24R, a pulse sensor 27, and the like.

In housing 21R, driver unit 22R is provided. Driver unit 22R is configured to output sound of a right channel according to an input right-channel audio signal. Acoustic cylinder part 23R comprises a pathway through which the sound of the right-channel output from driver unit 22R passes. The pathway in acoustic cylinder part 23R comprises an opening which faces the eardrum. The pulse sensor 27 is provided in proximity to the exterior wall of acoustic cylinder part 23R. More specifically, the pulse sensor 27 is secured to the exterior wall of acoustic cylinder part 23R. The pulse sensor 27 comprises a light-emitting diode (LED) and a photodiode (PD). The LED emits light and the PD detects the intensity of the light which is emitted from the LED and reflected by the body, whereby the pulse sensor 27 detects the pulse.

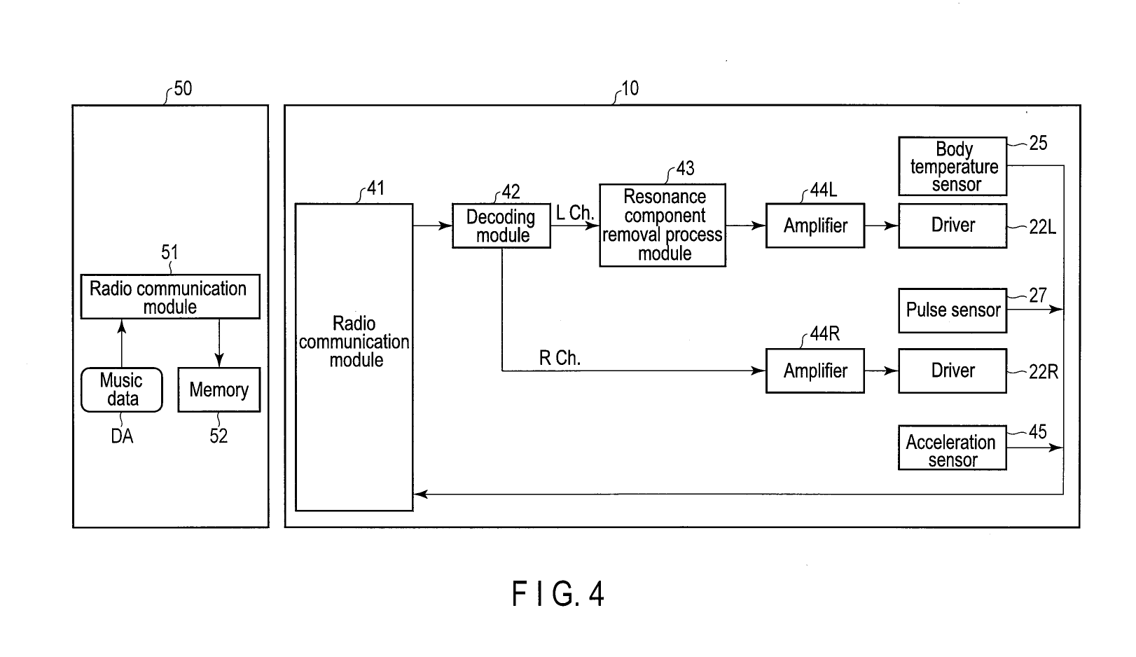

FIG. 4 is a block diagram of a system configuration of the auditory canal earphones 10.

As shown in FIG. 4, the earphones 10 comprise a radio communication module 41, a decoding module 42, a resonance component removal process module 43, an amplifier 44L, an amplifier 44R, an acceleration sensor 45, driver unit 22L, the body temperature sensor 25, driver unit 22R, acoustic cylinder part 23R, ear seating 24R, the pulse sensor 27 and the like.

The radio communication module 41 is configured to receive music data DA transmitted from a radio communication module 51 in a smartphone 50 which has a music player function. The decoding module 42 is configured to decode the received music data. The decoding module 42 is configured to output left-channel audio data to the resonance component removal process module 43. The decoding module 42 is configured to output right-channel audio data to amplifier 44R.

The resonance component removal process module 43 is configured to perform a correction process of removing a resonance component from the left-channel audio data to suppress resonance in acoustic cylinder part 23L. The resonance component removal process module 43 is configured to output the corrected left-channel audio data to amplifier 44L.

Amplifier 44L is configured to generate the left-channel audio signal based on the left-channel audio data to output sound from driver unit 22L. Amplifier 44L is configured to output the left-channel audio signal to driver unit 22L. Driver unit 22L is configured to output sound according to the left-channel audio signal.

Amplifier 44R is configured to generate the right-channel audio signal based on the right-channel audio data to output sound from driver unit 22R. Amplifier 44R is configured to output the right-channel audio signal to driver unit 22R. Driver unit 22R is configured to output the sound according to the right-channel audio signal.

The acceleration sensor 45 is configured to detect an acceleration.

In addition, the radio communication module 41 is configured to transmit physiological data collected by the body temperature sensor 25, the pulse sensor 27, the acceleration sensor 45 and the like by a radio signal.

The smartphone 50 is configured to receive the physiological data by the radio communication module 51. The smartphone 50 is configured to store the received physiological data in a memory 52. The smartphone 50 is configured to transmit the physiological data stored in the memory 52 to a cloud server.

Deterioration of sound quality caused by resonance in a sound pathway on the body temperature side is suppressed by an acoustic characteristic correction process. Both measurement of a deep part of body temperature by a thermopile and high-quality music reproduction by means of auditory canal earphones can be achieved simultaneously.

### First Modified Example

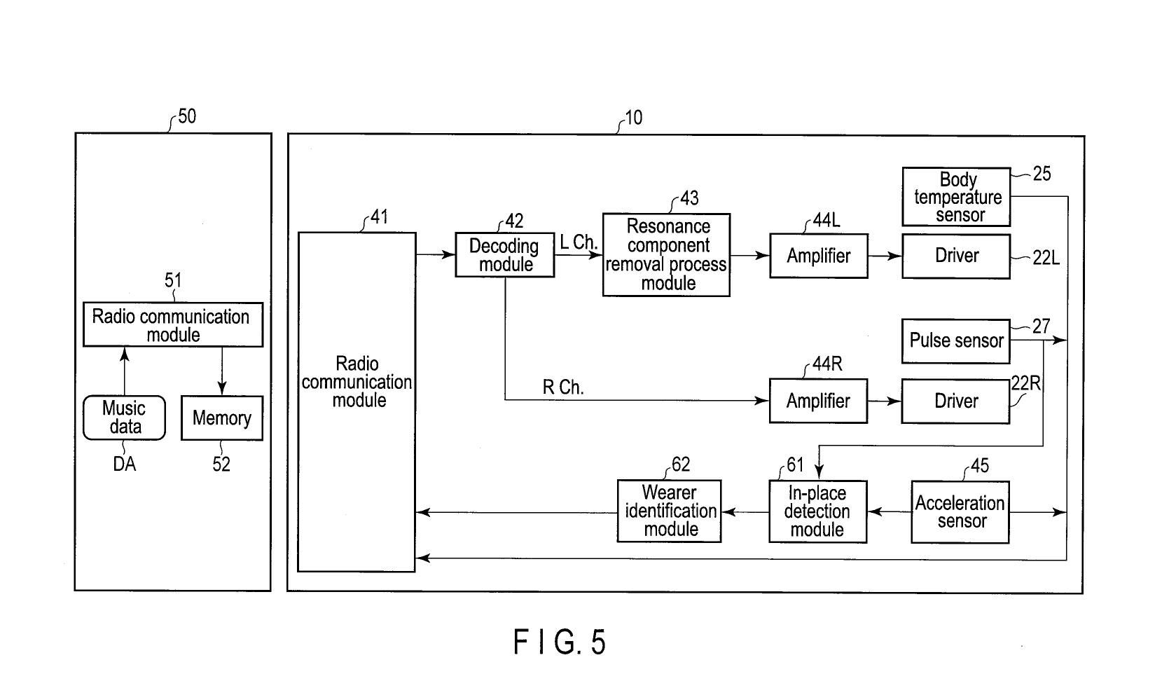

FIG. 5 is a block diagram of a system configuration of a first modified example of the earphones according to an embodiment. Note that, in FIG. 5, portions the same as those in FIG. 4 are denoted by the same reference numbers.

As shown in FIG. 5, the earphones 10 further comprise an in-place detection module 61 and a wearer identification module 62.

The in-place detection module 61 is configured to determine, when it receives data from the acceleration sensor 45 indicating a state of acceleration, that the earphones 10 are being moved from rest and are about to be put on and used. After the determination of the state of imminent use, if data transmitted from the pulse sensor 27 indicates detection of a normal pulse, the in-place detection module 61 determines that the earphones have been put on.

In the wearer identification module 62, one or more items of wearer identification data associated with a walking cadence or a pulse rate is registered with respect to a wearer ID which indicates a wearer. If the in-place detection module 61 detects that the earphones have been put on, the wearer identification module 62 performs sensing of the walking cadence with the acceleration obtained from the acceleration sensor 45 and also performs sensing of the pulse rate with the pulse obtained from the pulse sensor 27. The wearer identification module 62 is configured to identify the wearer ID corresponding to the wearer with the earphones on based on the wearer identification data in accordance with the walking cadence and pulse rate obtained by the sensing. The identified wearer ID is transmitted to the smartphone 50 by the radio communication module 41. The smartphone associates the transmitted wearer ID with the physiological data when storing the physiological data transmitted from the earphones 10 in the memory 52.

### Second Modified Example

FIG. 6 illustrates the exterior of a second modified example of the earphones according an embodiment. Note that, in FIG. 6, portions the same as those in FIG. 1 are denoted by the same reference numbers.

The earphones 10 further comprise myoelectric sensors 71L and 71R. The myoelectric sensors 71L and 71R are located at positions where they are brought into contact with the wearer's temples. The myoelectric sensors 71L and 71R are sensors configured to acquire an electromyogram.

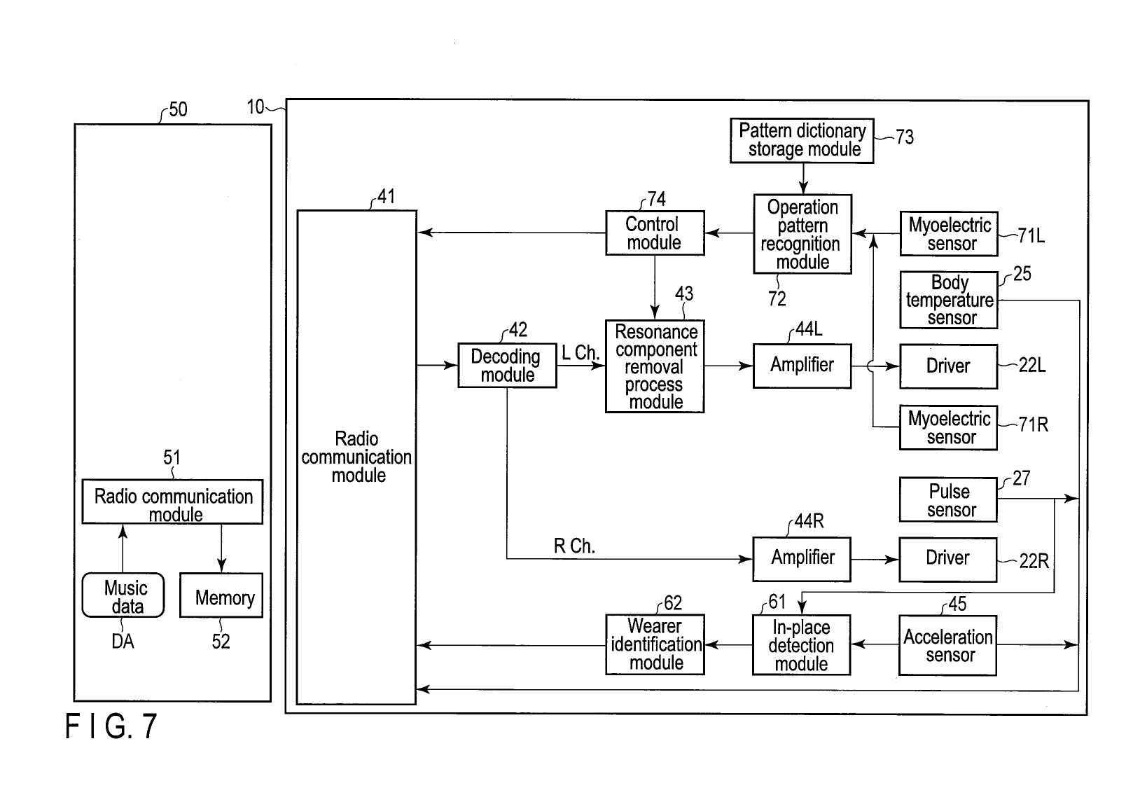

FIG. 7 is a block diagram of a system configuration of a second modified example of the earphones according to an embodiment. Note that, in FIG. 7, portions the same as those in FIG. 5 are denoted by the same reference numbers.

As shown in FIG. 7, the earphones 10 further comprise the myoelectric sensors 71L and 71R, an operation pattern recognition module 72, a pattern dictionary storage module 73, a control module 74, and the like.

The pattern dictionary storage module 73 is configured to store a plurality of operation pattern dictionaries in which an electromyographic signature is associated with an operation. For example, operations relating to music reproduction control such as fast-forwarding, volume adjustment, and equalization are associated with electromyographic signatures. In addition, for example, an operation relating to control of the earphones 10 such as a length of the resonance component removal is associated.

Data obtained by the myoelectric sensors 71L and 1R are transmitted to the operation pattern recognition module 72. The operation pattern recognition module 72 is configured to recognize an operation corresponding to the electromyographic signature according to the detected data based on the pattern dictionary storage module 73. The operation pattern recognition module 72 is configured to report operation data corresponding to the recognized operation. The controller 74 is configured to output an operation signal to operate the earphones 10 or the smartphone 50 data based on the reported operation.

### Third Modified Example

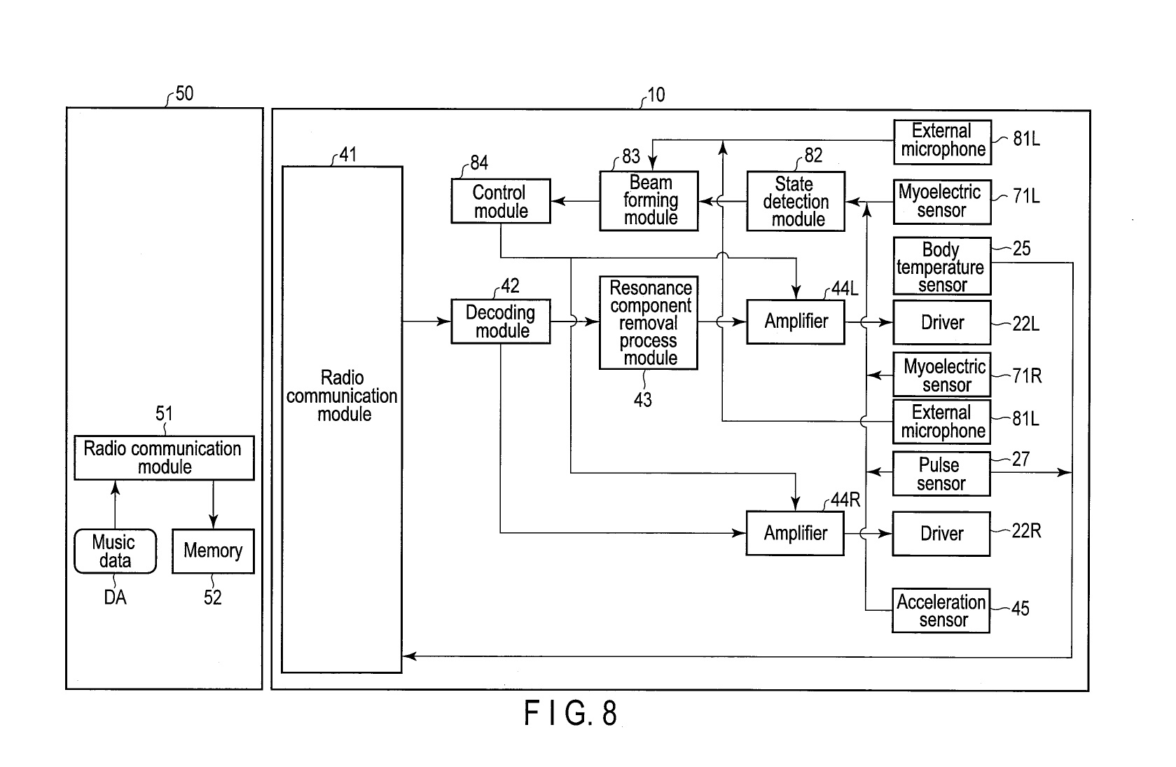

FIG. 8 is a block diagram of a system configuration of a third modified example of the earphones according to an embodiment. Note that, in FIG. 8, portions the same as those in FIG. 5 are denoted by the same reference numbers.

The earphones 10 further comprise external microphones 81L and 81R, a state detection module 82, a beam forming module 83, a control module 84 and the like.

The state detection module 82 is configured to detect a direction in which a user's attention is directed, the head is turned, and the eyes are turned, etc., based on the data detected by the pulse sensor 27, the acceleration sensor 45, and the myoelectric sensors 71L and 71R. The beam forming module 83 is configured to focus beam forming of the external microphones 81L and 81R in the detected direction. In other words, the directivity of the external microphones 81L and 81R is changed to the detected direction. The controller 84 is configured to change earphone output from music reproduction to the external microphones 81L and 81R if attention is suddenly caught or a particular noise (the sound of a car approaching) is detected.

### Fourth Modified Example

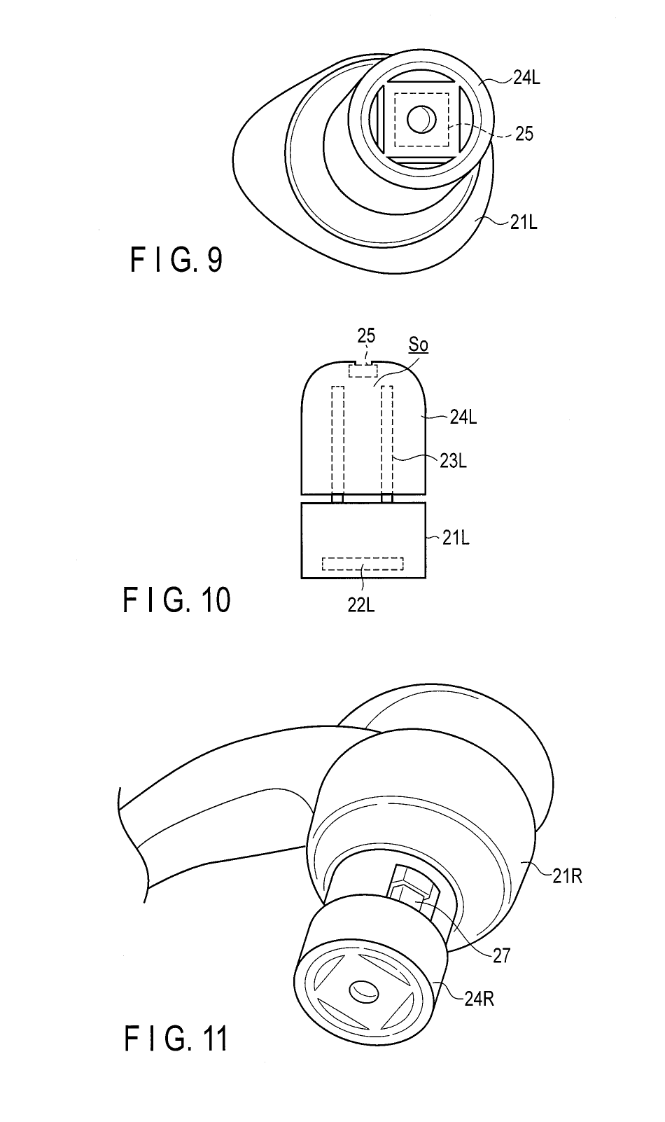

FIGS. 9 and 10 are block diagrams of a fourth modified example of a structure of the earphones according to an embodiment.

As shown in FIG. 9, the temperature sensor 25 may be embedded at the tip of ear seating 24L. Ear seating 24L around the temperature sensor 25 is provided with four apertures for sound output. In the case of the present modified example, as shown in FIG. 10, the temperature sensor 25 is provided above a plane So of the opening of acoustic cylinder part 23L.

### Fifth Modified Example

FIG. 11 is a block diagram of a structure of a fifth modified example of the earphones according to an embodiment.

In the earphones shown in FIG. 2, the pulse sensor 27 is secured to acoustic cylinder part 23R. However, as shown in FIG. 11, the pulse sensor 27 in here is embedded in ear seating 24R. The pulse sensor 26 is provided in proximity to the exterior wall of acoustic cylinder part 23R also in the present modified example.

The earphones according to the embodiments can prevent, in the case where a body temperature sensor is provided in an acoustic cylinder part, deterioration of output sound by performing correction so as to suppress acoustic resonance in a pathway of the acoustic cylinder part.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An audio device comprising:
a first driver configured to output a sound;
a first acoustic cylinder comprising a first pathway configured to be passed through by a sound, the first pathway comprising an opening configured to face an eardrum of a wearer;
a body temperature sensor provided substantially in an center of the opening or outside of a plane of the opening; and
a corrector configured to correct first audio data to suppress resonance in the first pathway,
wherein the first driver is configured to output corrected first sound according to corrected first audio data.

2. The device of claim 1, further comprising:
a second driver configured to output a second sound;
a second acoustic cylinder part comprising a second pathway through which the second sound output from the second driver passes;
a pulse sensor provided in proximity to an exterior wall of the second acoustic cylinder part and configured to detect the pulse; and
wherein the second driver is configured to output second sound according to corrected second audio data which is not corrected by the correction module.

3. The device of claim 2, further comprising:
an acceleration sensor configured to detect an acceleration; and
an identification module configured to identify the wearer according to a walking cadence of the wearer based on the acceleration detected by the acceleration sensor and a pulse rate detected by the pulse sensor.

4. The device of claim 1, further comprising:
a myoelectric sensor configured to acquire an electromyogram; and
an output module configured to output an operation signal to operate the device according to an electromyographic signature acquired by the myoelectric sensor.

5. The device of claim 1, further comprising:
a microphone; and
a controller configured to output, when a particular sound is collected by the microphone, the sound collected by the microphone from the first driver.

6. A control method of an audio device comprising a first driver configured to output a sound, a first acoustic cylinder comprising a first pathway configured to be passed through by a sound, the first pathway comprising an opening configured to face an eardrum of a wearer, a body temperature sensor provided substantially in an center of the opening or outside of a plane of the opening, the method comprising:
correcting audio data by a correction module to suppress resonance in the first pathway; and
outputting corrected first sound according to corrected first audio data.

7. The method of claim 6, wherein the device further comprises
a second driver configured to output a sound,
a second acoustic cylinder comprising a second pathway, which comprising an opening configured to face an eardrum of a wearer, configured to be passed through by a sound, the second pathway comprising an opening configured to face an eardrum of a wearer, and a pulse sensor provided in proximity to an exterior wall of the second acoustic cylinder and configured to detect the pulse,
the method further comprising:
outputting, by the second driver, second sound according to corrected second audio data which is not corrected.

8. The method of claim 7, wherein the device further comprises an acceleration sensor configured to detect an acceleration,
the method further comprising:
identifying the wearer according to a walking cadence of the wearer based on the acceleration detected by the acceleration sensor and a pulse rate detected by the pulse sensor.

9. The method of claim 6, wherein the device further comprising a myoelectric sensor configured to acquire an electromyogram,
the method further comprising:
outputting an operation signal to operate the audio device according to a signature of the acquired electromyogram.

10. The method of claim 6, wherein the audio device further comprises a microphone,
the method further comprising outputting, when a particular noise is collected by the microphone, the sound collected by the microphone from the first drive unit.
